(19) United States
(12) Patent Application Publication
(10) Pub. No.: US 2011/0225695 A1
(43) Pub. Date: Sep. 22, 2011

(54) LIFE-SAVING DEVICE

(76) Inventor: Chih-Wei CHENG, Zhongli City (TW)

(21) Appl. No.: 13/045,647

(22) Filed: Mar. 11, 2011

(30) Foreign Application Priority Data
Mar. 18, 2010 (TW) 099107917

(51) Int. Cl. B64D 10/00; B60R 21/26

(52) U.S. Cl. 2/2.14; 280/736

(57) ABSTRACT

A life-saving device has a garment and at least one airbag assembly. The at least one airbag assembly is mounted on the garment and each one of the at least one airbag assembly has a gas cylinder, a gas tube, multiple airbag layers and at least one connecting tube. The gas cylinder is attached to the garment. The gas tube is connected between the gas cylinder and the airbag layers. Each one of the at least one connecting tube is connected between two adjacent airbag layers. A user wearing the life-saving device can actuate the gas cylinder when falling from high altitudes to inflate the airbag layers via the gas tube and the at least one connecting tube. The inflated airbag layers will provide an air resistance to slow down the falling speed. Therefore, the user can safely descend to the ground.

### BACKGROUND OF THE INVENTION

1. Field of the Invention

The present invention relates to a life-saving device, and more particularly to a life-saving device that is applicable at high altitudes and high-rise buildings.

2. Description of the Prior Arts

Conventional life-saving devices for aircrafts include evacuation slides, life vests, lifeboats and the like. The evacuation slide is used to evacuate passengers and crew quickly when an aircraft makes an emergency on the ground or makes a crash landing and may explode thereafter. The life vests and the lifeboats are used to keep passengers and crew afloat when an aircraft makes an emergency water landing.

However, the conventional life-saving device are designed only considering situations in which an aircraft makes an emergency on the ground or makes a crash landing. Therefore, when an aircraft makes an emergency at high altitudes or is hijacked by terrorists, passengers and crew are unable to escape.

To overcome the shortcomings, the present invention provides a life-saving device to mitigate or obviate the aforementioned problems.

### SUMMARY OF THE INVENTION

The main object of the present invention is to provide a life-saving device to slow down the falling speed and save the user's life. To achieve the foregoing objective, the life-saving device in accordance with the present invention comprises a garment and at least one airbag assembly. The at least one airbag assembly is mounted on the garment and each one of the at least one airbag assembly has a gas cylinder, a gas tube, multiple airbag layers and at least one connecting tube. The gas cylinder is attached to the garment. The gas tube is connected between the gas cylinder and the airbag layers and has two ends. One of the ends of the gas tube is connected to the gas cylinder. The airbag layers are stacked from an inner side to an outer side in sequence and the other end of the gas tube is connected to the innermost airbag layer. Each one of the at least one connecting tube is connected between two adjacent airbag layers. A user wearing the life-saving device can actuate the gas cylinder when falling from high altitudes to inflate the airbag layers via the gas tube and the at least one connecting tube. The inflated airbag layers will provide an air resistance to slow down the falling speed. Therefore, the user can safely descend to the ground.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a life-saving device in accordance with the present invention showing airbag layers being received inside a garment;

FIG. 2 is an operational perspective view of the life-saving device in FIG. 1 showing the airbag layers being inflated;

FIG. 3 is a side view in partial section of a buffer of the life-saving device in accordance with the present invention showing the buffer being compressed;

FIG. 4 is a side view in partial section of the buffer of the life-saving device in FIG. 3 showing the buffer being stretched;

FIG. 5 is an enlarged exploded perspective view of the buffer of the life-saving device in FIG. 3; and

FIG. 6 is a partially enlarged side view in partial section of the buffer of the life-saving device in FIG. 3.

### DETAILED DESCRIPTION OF THE PREFERRED EMBODIMENTS

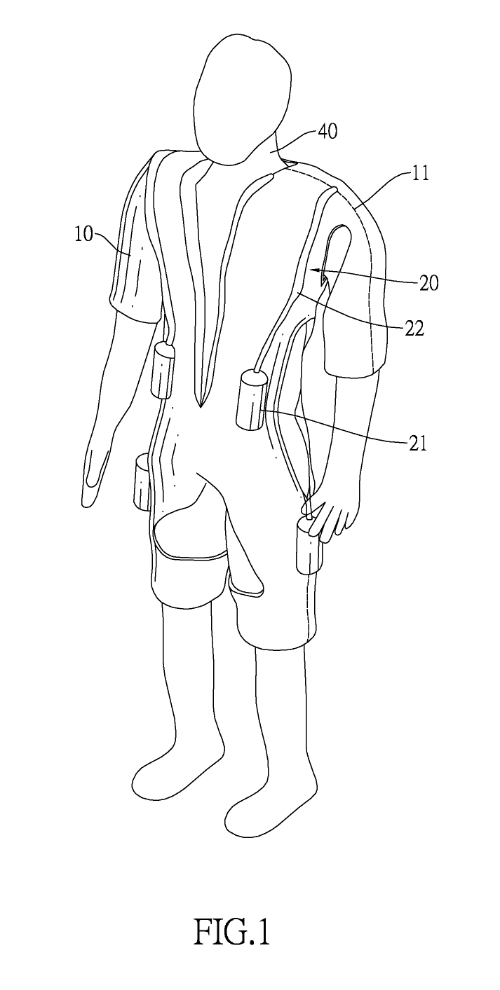

With reference to FIG. 1, a life-saving device in accordance with the present invention comprises a garment 10 and at least one airbag assembly 20. The garment 10 has an external surface, two shoulders, two thighs and multiple seams 11.

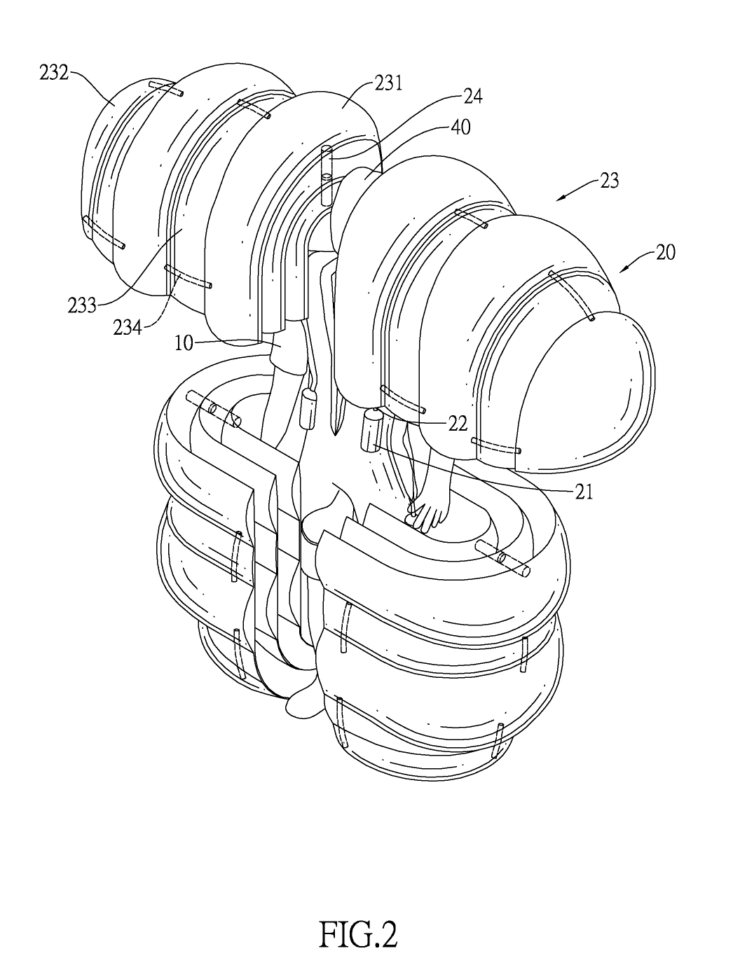

With further reference to FIG. 2, the at least one airbag assembly 20 is mounted on the garment 10 and each one of the at least one airbag assembly 20 has a gas cylinder 21, a gas tube 22, multiple airbag layers 23 and at least one connecting tube 24. The gas cylinder 21 is attached to the external surface of the garment 10. The gas tube 22 is connected between the gas cylinder 21 and the airbag layers 23 and has two ends. One of the ends of the gas tube 22 is connected to the gas cylinder 21. The airbag layers 23 are stacked from an inner side to an outer side sequentially and the other end of the gas tube 22 is connected to the innermost airbag layer 23. Each airbag layer 23 has a main airbag 231, at least one auxiliary airbag 232, at least one film 233 and multiple attaching tubes 234. The main airbag 231 and the at least one auxiliary airbag 232 are arranged in sequence. The at least one film 233 is connected between adjacent two of the main airbag 231 and the at least one auxiliary airbag 232, the attaching tubes 234 are respectively connected between the main airbag 231 and the at least one auxiliary airbag 232. Each one of the at least one connecting tube 24 is connected between two adjacent main airbags 231. The other end of the gas tube 22 is connected to the innermost main airbag 231.

In a preferred embodiment, the life-saving device comprises four airbag assemblies 20. The airbag assemblies 20 are mounted respectively on the shoulders and thighs of the garment 10.

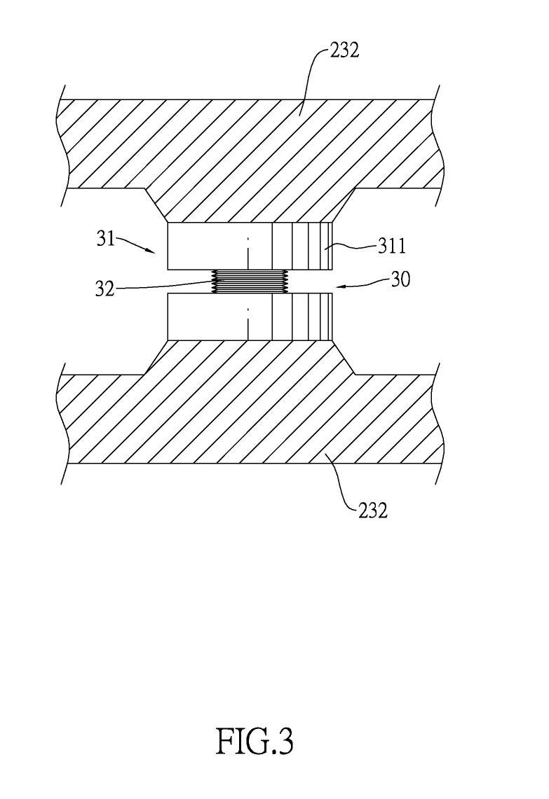

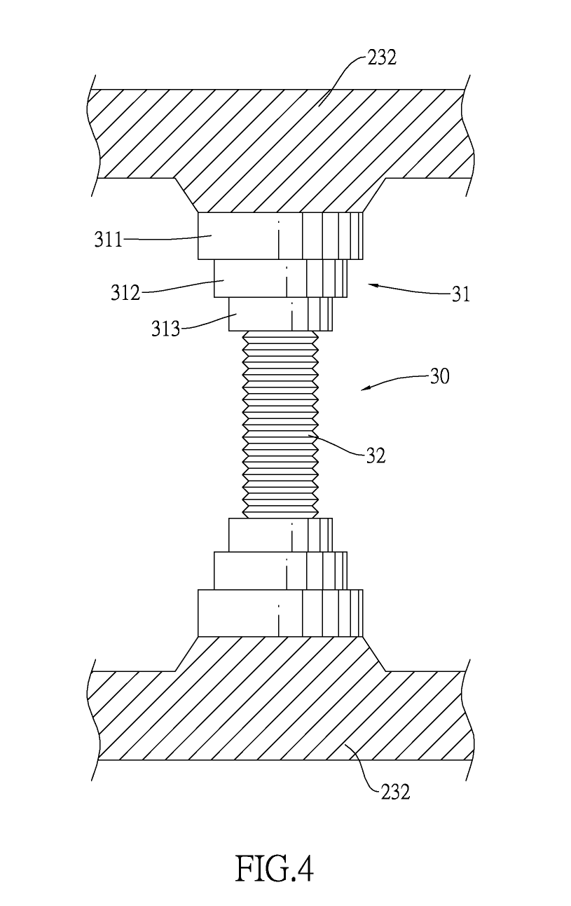

With reference to FIGS. 3 and 4, the life-saving device in accordance with the present invention further comprises multiple buffers 30 each mounted between the outermost auxiliary airbags 232 of the adjacent airbag layers 23 of one of the airbag assemblies 20. Each buffer 30 has two telescopic joints 31 and a flexible tube 32. Each telescopic joint 31 has an outer ring 311, at least one middle ring 312 and an inner ring 313. The outer ring 311 is connected to a corresponding auxiliary airbag 232. The at least one middle ring 312 is mounted through the outer ring 311. The inner ring 313 is mounted through the at least one middle ring 312. The flexible tube 32 is connected between the inner rings 313 of the telescopic joints 31.

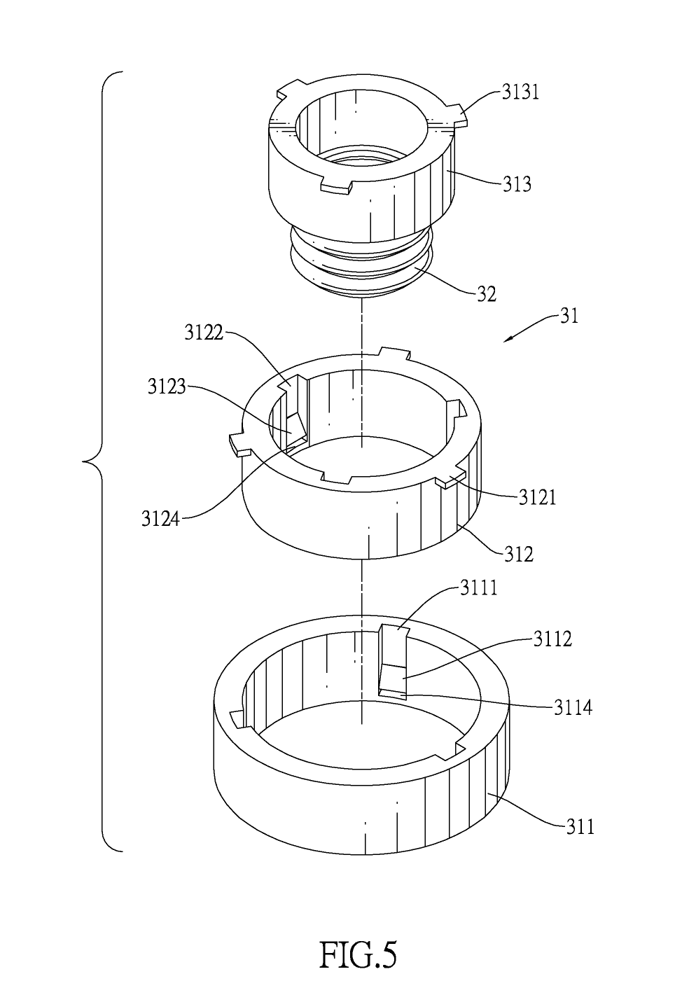

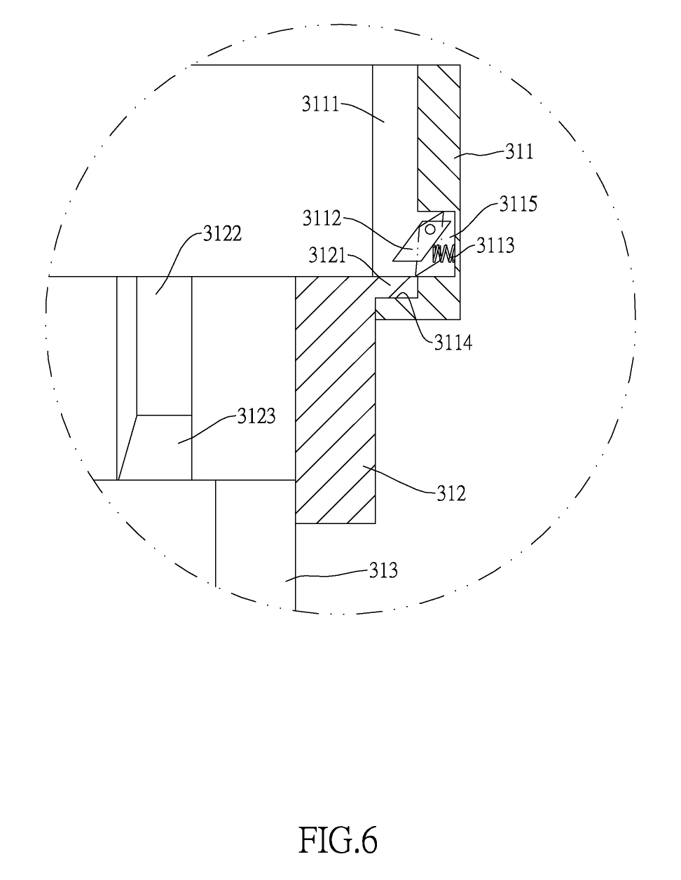

With further reference to FIGS. 5 and 6, the outer ring 311 has an internal surface, two open ends, multiple outer chutes 3111, multiple outer shearing pins 3112 and multiple outer springs 3113. The outer chutes 3111 are formed respectively in the internal surface and are arranged around one of the open ends of the outer ring 311. Each outer chute 3111 has an open end, an end surface 3114, a chute surface and a recess 3115. The recess 3115 is formed in the chute surface and has a recess surface. Each outer shearing pin 3112 is mounted in the recess 3115 of one of the outer chutes 3111 and has a pivoting end and a moving end. The pivoting end of the outer shearing pin 3112 is mounted pivotally in the recess 3115 of the outer chute 3111. Each outer spring 3113 is mounted securely on the recess surface of one of the recesses 3115 and abuts the moving end of a corresponding outer shearing pin 3112 to make the moving end of the outer shearing pin 3112 protrude out of the recess 3115 and position over a corresponding end surface 3114 of the outer chute 3111. The other open end of the outer ring 311 is connected to a corresponding auxiliary airbag 232.

Each one of the at least one middle ring 312 has the same structure as the outer ring 311 except that the middle ring 312 further has multiple middle protrusions 3121. Each one of the at least one middle ring 312 has an internal surface, an external surface, an open end, multiple middle protrusions 3121, multiple middle chutes 3122 and multiple middle shearing pins 3123. The middle protrusions 3121 protrude respectively from the external surface and are arranged around the open end of the at least one middle ring 312. Each middle protrusion 3121 is received in one of the outer chutes 3111 of the outer ring 311. When the middle protrusions 3121 abuts with the moving ends of the outer shearing pins 3112 during assembling the middle ring 312 into the outer ring 311, the outer shearing pins 3112 will be pivot and compress the outer springs 3113 to make the moving ends of outer shearing pins 3112 are retracted into the recesses 3115. Consequently, the middle protrusions 3121 are allowed to pass over the outer shearing pins 3112 and to abut the end surface 3114 of the outer ring 311. After the middle protrusions 3121 passing over the outer shearing pins 3112, the outer shearing pins 3112 are pivoted to make the moving ends of the outer shearing pins 3112 extending out of the recesses 3115 by the force provided by the outer spring 3113. Accordingly, the middle protrusions 3121 are disposed between the end surface 3114 of the outer chute 3111 in the outer ring 311 and the outer shearing pins 3112. The middle chutes 3122 are formed respectively in the internal surface and are arranged around the open end of the at least one middle ring 312, and each middle chute 3122 has an end surface 3124. Each middle shearing pin 3123 is mounted pivotally in one of the middle chutes 3122.

The inner ring 313 has an external surface, two open ends and multiple inner protrusions 3131. The inner protrusions 3131 protrude respectively from the external surface and are arranged around one of the open ends of the inner ring 313. Each inner protrusion 3131 is received in one of the middle chute 3122 of the at least one middle ring 312 and is disposed between the end surface 3124 of a corresponding one of the middle chute 3122 in a corresponding middle ring 312 and the middle shearing pin 3123. The flexible tube 32 has two ends connected respectively to the other open ends of the inner rings 313 of the telescopic joints 31.

With reference to FIG. 1, before using the life-saving device in accordance with the present invention, the airbag assemblies 20 are not inflated and are mounted inside the garment 10. When an emergency occurs at high altitudes or high-rise buildings and people must jump from high places to escape, people wear the life-saving device at that time. With further reference to FIG. 2, the gas cylinders 21 are then actuated so the pressured gas inside the gas cylinders 21 sequentially inflates the main airbags 231 of the airbag layers 23 from the inner side to the outer side via the gas tubes 22 and connecting tubes 24. Gas inside the main airbags 231 further inflates the auxiliary airbags 232 via the attaching tubes 234. Besides, the inflated main airbags 231 and auxiliary airbags 232 will pop out from the seams 11 of the garment 10 and provide an air resistance. Therefore, the falling speed of the user 40 can be slowed down and the user 40 can safely descend to the ground. With reference to FIG. 3, the telescopic joints 31 and flexible tubes 32 of the buffers 30 are compressed before the auxiliary airbags 232 are inflated. With reference to FIG. 4, when the auxiliary airbags 232 are inflated and airflow during falling generates tensile force between adjacent auxiliary airbags 232, the telescopic joints 31 and flexible tubes 32 of the buffers 30 are stretched. With reference to FIGS. 5 and 6, each middle protrusion 3121 of the middle rings 312 is disposed between the corresponding end surface 3114 and outer shearing pin 3112. Each inner protrusion 3131 is disposed between corresponding end surface 3124 and middle shearing pin 3123. The stretched buffers 30 allow the auxiliary airbags 232 to connect to each other stably.

Tensile force between adjacent auxiliary airbags 232 is disappeared at the moment of that the user 40 descends to the ground so the stretched buffers 30 are compressed and the middle and inner protrusions 3121, 3131 of the middle and inner rings 312, 313 abut tightly the outer and middle shearing pins 3112, 3123. In addition, when the user 40 descends to the ground, the ground gives a reaction force to the user 40. If the reaction force applied on the auxiliary airbags 232 is bigger than a level that the outer and middle shearing pins 3112, 3123 can bear, the outer and middle shearing pins 3112, 3123 will be fractured. Thus, buffering effect is achieved to prevent the reaction force from being too big to harm the user 40.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A life-saving device comprising:
a garment having an external surface; and
at least one airbag assembly mounted on the garment, and each one of the at least one airbag assembly having
a gas cylinder attached to the external surface of the garment;
multiple airbag layers stacked from an inner side to an outer side sequentially and including an innermost airbag layer;
a gas tube connected between the gas cylinder and the airbag layers and having two ends, one of the ends connected to the gas cylinder and the other end connected to the innermost airbag layer; and
at least one connecting tube, and each one of the at least one connecting tube connected between adjacent two of the airbag layers.

2. The life-saving device as claimed in claim 1, wherein
each airbag layer of the at least one airbag assembly has a main airbag and at least one auxiliary airbag arranged in sequence and the at least one auxiliary airbag including an outermost auxiliary airbag;
one of the ends of the gas tube of each one of the at least one airbag assembly is connected to the main airbag of the innermost airbag layer of the airbag assembly; and
the life-saving device further comprises multiple buffers each mounted between each the outermost auxiliary airbags of adjacent two of the airbag layers of one of the at least one airbag assembly.

3. The life-saving device as claimed in claim 2, wherein each buffer has two telescopic joints and a flexible tube connected between the telescopic joints.

4. The life-saving device as claimed in claim 3, wherein
each telescopic joint of each buffer has
an outer ring having
an internal surface;
two open ends;
multiple outer chutes formed respectively in the internal surface and arranged around one of the open ends of the outer ring, the other open end of the outer ring connected to a corresponding auxiliary airbag and each outer chute having
an open end;
an end surface;
a chute surface; and
a recess formed in the chute surface and has a recess surface;
multiple outer shearing pins and each outer shearing pin mounted pivotally in the recess of one of the outer chutes; and
multiple outer springs and each outer spring mounted securely on the recess surface of one of the recesses of the outer chutes and abutting a corresponding outer shearing pin;
at least one middle ring mounted through the outer ring and each one of the at least one middle ring having
an internal surface;
an external surface;
an open end;
multiple middle protrusions protruding respectively from the external surface and are arranged around the open end of the at least one middle ring and each middle protrusion received in one of the outer chutes of the outer ring and disposed between the end surface of a corresponding one of the outer chute in the outer ring and the outer shearing pin;
multiple middle chutes formed respectively in the internal surface and arranged around the open end of the at least one middle ring and each middle chute having an end surface; and
multiple middle shearing pins and each middle shearing pin mounted pivotally in one of the middle chutes; and
an inner ring mounted through the at least one middle ring and the inner ring having
an external surface;
two open ends; and
multiple inner protrusions protruding respectively from the external surface and arranged around one of the open ends of the inner ring and each inner protrusion received in one of the middle chutes of the at least one middle ring and disposed between the end surface of a corresponding one of the middle chute in a corresponding middle ring and the middle shearing pin; and
the flexible tube of the buffer has two ends connected respectively to the other open ends of the inner rings of the telescopic joints.

5. The life-saving device as claimed in claim 2, wherein each airbag layer further has
at least one film connected between adjacent two of the main airbag and the at least one auxiliary airbag; and
multiple attaching tubes respectively connected between the main airbag and the at least one adjacent main airbag.

6. The life-saving device as claimed in claim 3, wherein each airbag layer further has
at least one film connected between adjacent two of the main airbag and the at least one auxiliary airbag; and
multiple attaching tubes respectively connected between the main airbag and the at least one adjacent main airbag.

7. The life-saving device as claimed in claim 4, wherein each airbag layer further has
at least one film connected between adjacent two of the main airbag and the at least one auxiliary airbag; and
multiple attaching tubes respectively connected between the main airbag and the at least one adjacent main airbag.

8. The life-saving device as claimed in claim 1, wherein
the garment has two shoulders, two thighs and multiple seams; and
the life-saving device comprises four airbag assemblies mounted respectively on the shoulders and thighs of the garment.

9. The life-saving device as claimed in claim 2, wherein
the garment has two shoulders, two thighs and multiple seams; and
the life-saving device comprises four airbag assemblies mounted respectively on the shoulders and thighs of the garment.

10. The life-saving device as claimed in claim 3, wherein
the garment has two shoulders, two thighs and multiple seams; and
the life-saving device comprises four airbag assemblies mounted respectively on the shoulders and thighs of the garment.

11. The life-saving device as claimed in claim 4, wherein
the garment has two shoulders, two thighs and multiple seams; and
the life-saving device comprises four airbag assemblies mounted respectively on the shoulders and thighs of the garment.

12. The life-saving device as claimed in claim 5, wherein
the garment has two shoulders, two thighs and multiple seams; and
the life-saving device comprises four airbag assemblies mounted respectively on the shoulders and thighs of the garment.

13. The life-saving device as claimed in claim 6, wherein
the garment has two shoulders, two thighs and multiple seams; and
the life-saving device comprises four airbag assemblies mounted respectively on the shoulders and thighs of the garment.

14. The life-saving device as claimed in claim 7, wherein
the garment has two shoulders, two thighs and multiple seams; and
the life-saving device comprises four airbag assemblies mounted respectively on the shoulders and thighs of the garment.
